(19) United States
(12) Patent Application Publication
(10) Pub. No.: US 2025/0356776 A1
(43) Pub. Date: Nov. 20, 2025

(54) METHOD AND SYSTEM OF ADAPTIVE TESTING VIA CONTINUOUS REAL TIME SCORING

(71) Applicant: EXAMROOM.AI CORP., LAKE MARY, FL (US)

(72) Inventors: VINOD KUMAR JAYAKEERTHI, Sorrento, FL (US); PHILIP DUWAYNE DICKISON, Clearwater Beach, FL (US); HENRY LUND SORENSEN, Sandy, UT (US); BHARATH VIRUPAKSHAPPA SAGAR, Shimoga (IN); DEEPAK MADHUKAR KOLEKAR, Bengaluru (IN)

(21) Appl. No.: 19/017,917

(22) Filed: Jan. 13, 2025

Related U.S. Application Data
(60) Provisional application No. 63/649,014, filed on May 17, 2024.

(51) Int. Cl. G09B 7/00

(52) U.S. Cl. CPC G09B 7/00

(57) ABSTRACT

A method and system of adaptive testing via continuous real time scoring. The method comprises scoring a first performance submission received from a candidate computing device in accordance with a first item sourced from the item bank that is presented to the candidate computing device, selecting, from the plurality of unique test items of the item bank, one of a more and a less difficult at least a second item, scoring an at least a second performance submission received from the candidate computing device, generating a candidate performance profile based at least on the first and the at least a second performance submissions received, and assigning either a conclusive fail or a conclusive pass based on the candidate performance profile as generated.

### RELATED APPLICATIONS

This application claims the benefit of priority to U.S. Provisional Patent Application No. 63/649,014 filed on May 17, 2024. Said U.S. Provisional Patent Application No. 63/649,014 is hereby incorporated in its entirety.

### TECHNICAL FIELD

Disclosures herein relate to distributed computer network systems for deployment in varying examination testing contexts.

### BACKGROUND

The introduction and increasing prevalence of online examinations has necessitated a requirement for secure, reliable and efficient technologies that facilitate a seamless testing experience while maintaining integrity of examination ecosystems, including related examination proctoring solutions. From a practical standpoint, it can be challenging for proctoring and related test administration solutions, especially in context of remotely located candidates, to accurately, consistently and objectively evaluate candidates. Tests that are uniquely and appropriately customized to a particular test candidate, while ensuring fair and scalable deployment, are desired.

### DESCRIPTION OF THE DRAWINGS

Whereas novel aspects believed characteristic of the invention are set forth in the appended claims, embodiments described herein will be understood by those of skill in the art with reference to the following detailed description and accompanying drawing figures in which like reference numerals indicate similar or identical features and components.

FIG. 1 shows, in an example embodiment, a distributed computer network system for adaptive testing via real time continuous scoring.

FIG. 2 shows, in an example embodiment, an architecture of a test delivery server computing system for adaptive testing via real time continuous scoring.

FIG. 3 shows, in an example embodiment, a scheme for implementing adaptive testing via real time continuous scoring.

FIG. 4 shows, in an example embodiment, a process for deploying adaptive testing via real time continuous scoring.

FIG. 5 shows, in another example embodiment, a process for deploying adaptive testing via real time continuous scoring.

### DETAILED DESCRIPTION

Embodiments herein recognize challenges in creating and administering examinations, on-site as well as online for remotely located examination candidates while maintaining integrity and quality standards of the examination process without undue risk of compromise. Among other advantages and benefits, techniques for distributed network computer adaptive testing (CAT) are provided herein. In particular, techniques, processes, systems and features disclosed herein enhance the accuracy of assessments while also significantly reducing the time and number of test questions (‘items’ as referred to herein) needed to gauge candidate performance or proficiency. Techniques disclosed herein also enable customized selection of items for presentation to a given test candidate based on demonstrated proficiency and performance in real time as the candidate continuously progresses through sequences of items in accordance with mandated topics that a given test must assess.

Proctoring and test administration solutions disclosed herein allow customized selection of items for test candidates (‘candidates’ as variously referred to herein) based on appropriately levels of difficulty, as determined in real time for a given candidate. Embodiments disclosed herein enable an efficient, fair, scalable and highly personalized testing experience in which some candidates may be presented with less or more questions than other or counterpart candidates in accordance with continuously determining, in real time during performance of the test, to be more or less proficient in accordance with a level of difficulty of items presented for candidate performance. As the test progresses, the system intelligently assesses the candidate's responses, or performance, calculating their proficiency level in real-time. In specific embodiments, candidates who are able to consistently perform well when presented with items of increasing level of difficulty during the test may be able to achieve a conclusive ‘pass’ status prior to completion of an entire amount and sequence of items that might have been predetermined or proscribed as a target for completion or performance in a given examination. Embodiments herein continuously re-calculates and recalibrates, in real time, a candidate's ability based on their previous responses to questions as well as based on the difficulty level of those questions. This process guides the selection of the next question where candidate ability may merit more difficult items, and an examination can be concluded faster, with benefits of less exposure of individual items from a given item bank, to the potential population of candidates. In this manner, less exposure of items to the populace of candidates minimizes risk of compromise and maintains integrity of the items and item content as crafted.

As referred to herein, an ‘item’ refers to a question or task presented for performance by a candidate in order to assess the candidate's skills, knowledge or proficiency in a particular subject. Such items may be sourced from an ‘item pool’, or ‘item bank’ as variously referred to herein, comprising a population or collection of all questions approved or otherwise designated for testing on a given examination or topic. Each question in the item pool may be pre-designated in accordance with specific classifications and details including, but not limited to, a level of difficulty, for deployment in the CAT contexts, including linear on the fly (LOFT) examinations

Provided is a method of adaptive testing via continuous real time scoring. The method comprises scoring a first performance submission received from a candidate computing device in accordance with a first item sourced from the item bank that is presented to the candidate computing device, selecting, from the plurality of unique test items of the item bank, one of a more and a less difficult at least a second item, scoring an at least a second performance submission received from the candidate computing device, generating a candidate performance profile based on the first and the at least a second performance submissions received, and assigning either a conclusive fail or a conclusive pass based on the candidate performance profile as generated.

Further provided is a test delivery server computing system communicatively coupled within a distributed network computing system. The test delivery server includes one or more processors and a memory storing instructions executable in the one or more processors. The instructions, when executed, cause the processor(s) to implement operations including scoring a first performance submission received from a candidate computing device in accordance with a first item sourced from the item bank that is presented to the candidate computing device, selecting, from the plurality of unique test items of the item bank, one of a more and a less difficult at least a second item, scoring an at least a second performance submission received from the candidate computing device, generating a candidate performance profile based on the first and the at least a second performance submissions received, and assigning either a conclusive fail or a conclusive pass based on the candidate performance profile as generated.

Also provided is a computer-readable non-transitory memory having instructions stored thereon. The instructions are executable to cause one or more processors to implement operations including scoring a first performance submission received from a candidate computing device in accordance with a first item sourced from the item bank that is presented to the candidate computing device, selecting, from the plurality of unique test items of the item bank, one of a more and a less difficult at least a second item, scoring an at least a second performance submission received from the candidate computing device, generating a candidate performance profile based on the first and the at least a second performance submissions received, and assigning either a conclusive fail or a conclusive pass based on the candidate performance profile as generated.

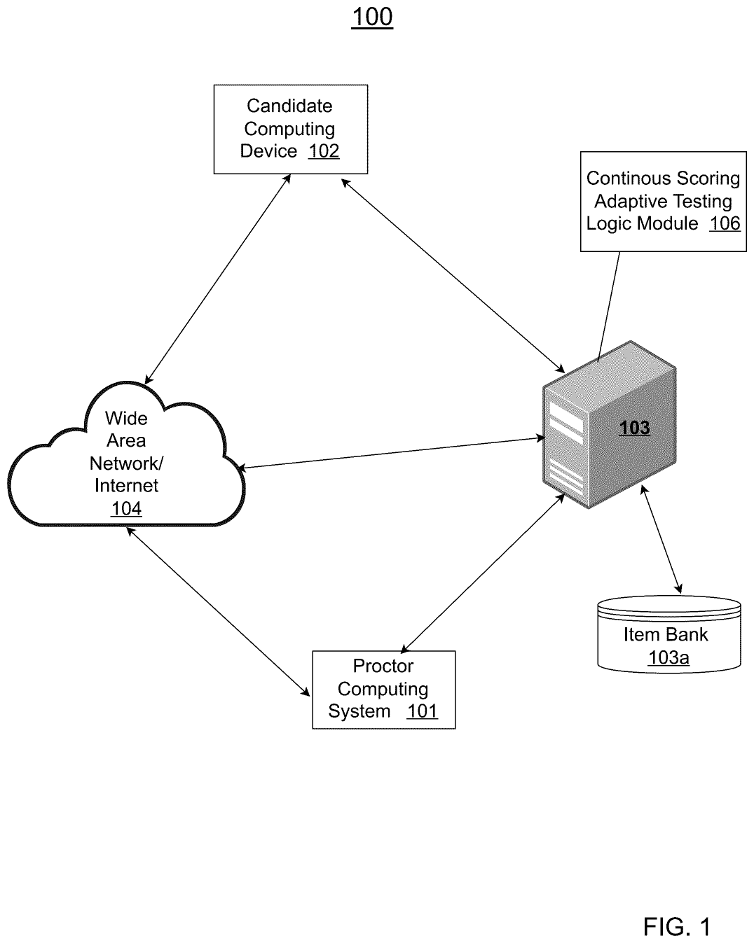

FIG. 1 shows, in an example embodiment, distributed computer network system 100 for adaptive testing via real time continuous scoring. In embodiments, network system 100 includes continuous scoring adaptive testing logic module 106 of test delivery server computing system 103. Continuous scoring adaptive testing logic module 106 may be constituted of processor-executable instructions stored in a memory of test delivery server computing system 103, or in some embodiments, proctor computing system 101, The instructions may then be instantiated via execution of the processor-executable instructions as stored. Test delivery server computing system 103 may be interconnected with proctor computing system 101, candidate computing device 102 for a candidate taking an examination, and database item bank 103a. In some embodiments, test delivery server computing system 103 may incorporate database item bank 103a. It is contemplated that the executable instructions may be stored in portions or components across test delivery server computing system 103 in conjunction with proctor computing system 101, implemented in parts or in whole across one or both of test delivery server computing system 103 in conjunction with proctor computing system 101 in combination, in some variations. Test delivery server computing system 103 and proctor computing system 101 may be interconnected directly, or via a local area network or wide area network 104, in some embodiments. In this manner, network system 100 for adaptive testing may be deployed using processor devices and memory in any one of test delivery server computing system 103 and proctor computing system 101 or across both test delivery server computing system 103 and proctor computing system 101 working cooperatively, as will be apparent to those of skill in the art of distributed computer networking systems and cloud computing systems.

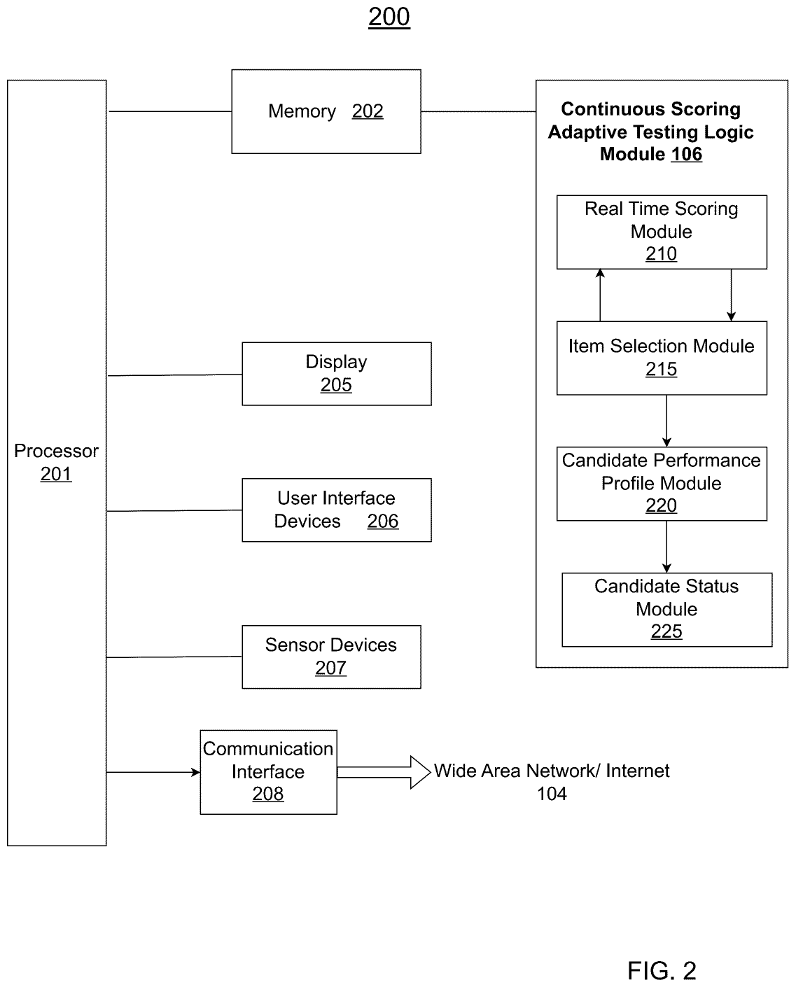

FIG. 2 shows, in an example embodiment, architecture 200 of a test delivery server computer system 103 within distributed computer network system 100 for adaptive testing via real time continuous scoring. The example embodiment of architecture 200 will be described with reference to test delivery server computing system 103 rendering a test having a plurality of test questions (‘items’) sourced from an item bank that includes a plurality of unique test items. However, it is contemplated that, as will be appreciated by ones of skill in the art of distributed computing networks, at least some portions of logic componentry and functionality ascribed to test delivery server computing system 103 may be incorporated into proctor computing system 101, or similar interconnected computing systems, in alternate or additional embodiments. For instance, it is contemplated that at least some of the functionality of continuous scoring adaptive testing logic module 106, including item selection module 210 and skills based examination deployment module 215 may be implemented or incorporated variously, including in portions or an entirety, across test delivery server computing system 103 in conjunction with proctor computing system 101, communicatively coupled by way of communication interface 208 via wide area network 104.

In embodiments, test delivery server computer system 103 may include memory 202, processor 201, display 205, user interface devices 206, sensor devices 206 such as a camera or imaging sensor, and communication interface 208 that provides interconnectivity with wide area network 104.

Continuous scoring adaptive testing logic module 106, constituted of item selection module 210, skills based examination deployment module 215, candidate performance module 220 and candidate status module 225 may be implemented using programmable instructions stored in memory 202, and being executable in one or more processor devices, including such as processor 201. Memory 202 may include, though not necessarily be limited to, non-volatile memory device(s), including dynamic random access memory (DRAM) or static random access memory (SRAM) non-transitory memory storage media or devices, and any combinations thereof. Although functionality ascribed to continuous scoring adaptive testing logic module 106 is described herein, for sake of providing clarity to ones of ordinary skill in the art, in context of discrete logic modules, item selection module 210 and real time scoring module 215, candidate performance module 220 and candidate status module 225, it is expected that functionality ascribed to continuous scoring adaptive testing logic module 106 herein should not be limited in implementation to literal discrete logic modules as real time scoring module 210, item selection module 215, candidate performance module 220 and candidate status module 225 used to describe example embodiments herein. For instance, in alternate or additional embodiments, certain aspects of those discrete modules may be incorporated or subsumed, at least in portions, variously across others of those discrete logic modules.

In some variations, at least some portions of functionality of continuous scoring adaptive testing logic module 106 including its constituent logic modules, specifically real time scoring module 210, item selection module 215, candidate performance module 220 and candidate status module 225 may be implemented in accordance with hard-wired circuitry and electronic componentry. The hard-wired circuitry and electronic componentry may be, without limitation, such as field programmable gate array (FPGA) devices, application specific integrated circuit (ASIC) devices and similar hard-wired electronic circuitry and componentry device implementations.

Real time scoring module 210 includes logic instructions for implementing functionality that includes scoring a first performance submission received from candidate computing device 102 in accordance with a first item sourced from the item bank 103a that is presented to the candidate computing device 102. Candidate responses, or performance as referred to herein, for subsequent questions are continuously scored as received in real time from the candidate computing device in accordance with the more and the less difficult items selected by item selection module 215.

Item selection module 215, in embodiments, includes logic instructions for implementing functionality related to selecting, from the plurality of unique test items of the item bank, one of a more and a less difficult second, or subsequent items. Depending on candidate success in answering an immediately prior item, more challenging or difficult questions may be selected, and the candidate performance profile may be continuously updated as each subsequent items is completed, with the more difficult items, when successfully performed or completed meriting a higher score for the test candidate.

In some aspects, the plurality of unique test items of the item bank may be distributed among a set of predefined test topics, each predefined test topic of the set including a subset of the plurality that share a classification in accordance with respective ones of multiple levels of difficulty. The classifications may be predetermined in accordance with the multiple levels of difficulty based at least in part on a cumulative history of performance by an entire population of prior test candidates. In some embodiments, the classification of more difficult items item comprises a performance success probability of 40% or less, and items classified as less difficult comprise a performance success probability of 60% or more, the more difficult and the less difficult classifications of items being respectively distributed below and above a target success probability that is predefined in accordance with a 50% success probability. The classifications may be subject to further sub-divisions or sub-classifications in difficulty level, in some variations.

Candidate performance profile module 220, in embodiments, includes logic instructions for implementing functionality related to generating a candidate performance profile based on all performance submissions as received in real time from the candidate device. The candidate performance profile includes at least the scoring results for all items performed, or completed, by the candidate during the examination.

In some embodiments, the candidate performance profile comprises performance results selected from prior examination performance results from examination undertakings by a given test candidate associated with the candidate computing device. Yet further, in some variations, the first item may be selected in accordance with a first level of difficulty that is established based at least in part upon the prior examination performance results of the test candidate.

Candidate status module 225, in embodiments, includes logic instructions for implementing functionality related to assigning one of a conclusive fail and a conclusive pass status based on the candidate performance profile as generated. In embodiments, the conclusive fail status is assigned prior to scoring the target subset upon receiving the at least a second performance submission in accordance with the less difficult at least a second item.

In some embodiments, the test comprises one or more of linear and linear on the fly test (LOFT) test configurations, and the test is concluded responsive to assigning the one of the conclusive fail and the conclusive pass status. In some variations, the conclusive pass status and the conclusive fail status are respectively assigned responsive to at least one of a predetermined number of the first and at least a second items and a predetermined percentage of the first and at least a second items being answered correctly or incorrectly based on the real time continuous scoring.

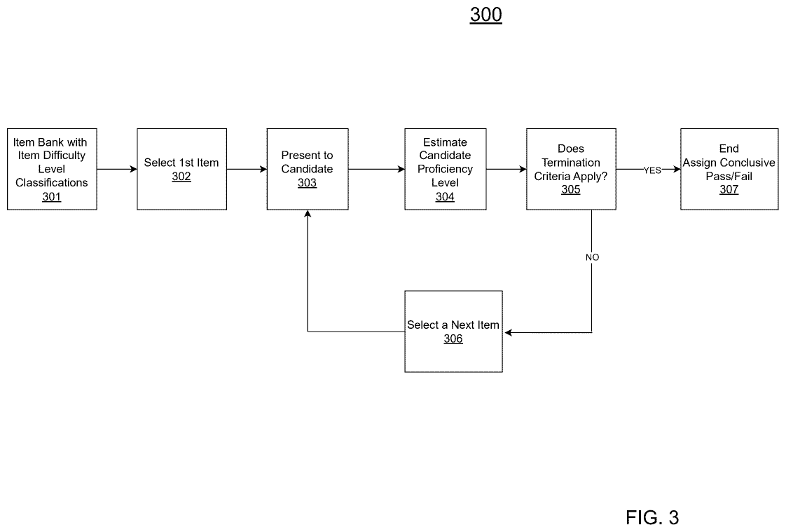

FIG. 3 shows, in an example embodiment, a scheme 300 for implementing adaptive testing via real time continuous scoring. In embodiments, scheme 300 may be implemented by applying any of the devices, systems, and features as described in FIGS. 1-5 for use in conjunction with scheme 300.

Block 301 represents item bank 103a storage of unique items crafted for particular examinations or examination topics. In embodiments, items for a given examination or a given examination topic may be pre-arranged or pre-classified according to varying levels of difficulty. An objective and empirical standard for such pre-classification may be based on actual candidate population prior performance for each given item, with an average or median level of difficulty being set for a 50% chance of candidate success, as observed from prior examinations taken by test candidates cumulatively. More difficult items may be set, or classified, according to a 40% or less chance of candidate success. Less difficult items may be classified as those items associated with a 60% chance of candidate success. It is contemplated, however, that other cutoff percentage levels, or ranges thereof, may be applied in classifying, or defining, items according to the more difficult and less difficult standards. Furthermore, within each classification, sub-classifications may be defined, with the most exclusive, or highest difficulty level, sub-classification meriting a candidate the highest score or credit for the given item when answered or performed correctly.

Block 302 shows selecting of a first item from the item bank 103a.

Block 303 represents presentation of each item as sequentially selected, based on test item selection criteria, to a test candidate.

Block 304 represents continuously estimating or calculating, and updating, a candidate proficiency level in real time as each item is completed.

Block 305 represents determining whether test termination criteria apply. In one embodiment, a cumulative or combined test score attained by a candidate may indicate a conclusive pass state or level, at which point the test may be terminated. In embodiments where a candidate has successfully performed in response to high difficulty level questions that are presented, a conclusive pass may be merited at earlier time, based on the scoring, as compared with a candidate who has been presented, or merited, mainly less difficult items for performance.

Block 306 represents continuing the test based on selecting a next item for presentation to the test candidate. Based on a successful performance on an immediately prior item, the candidate may merit a more difficult item. In this manner, selection of items for a given test candidate provides a dynamically customized test in real time for a given candidate based on their actual performance in accordance with scoring of test items.

Block 307 represents an end point for the test based on assigning a conclusive pass or fail as may be merited according to the scoring.

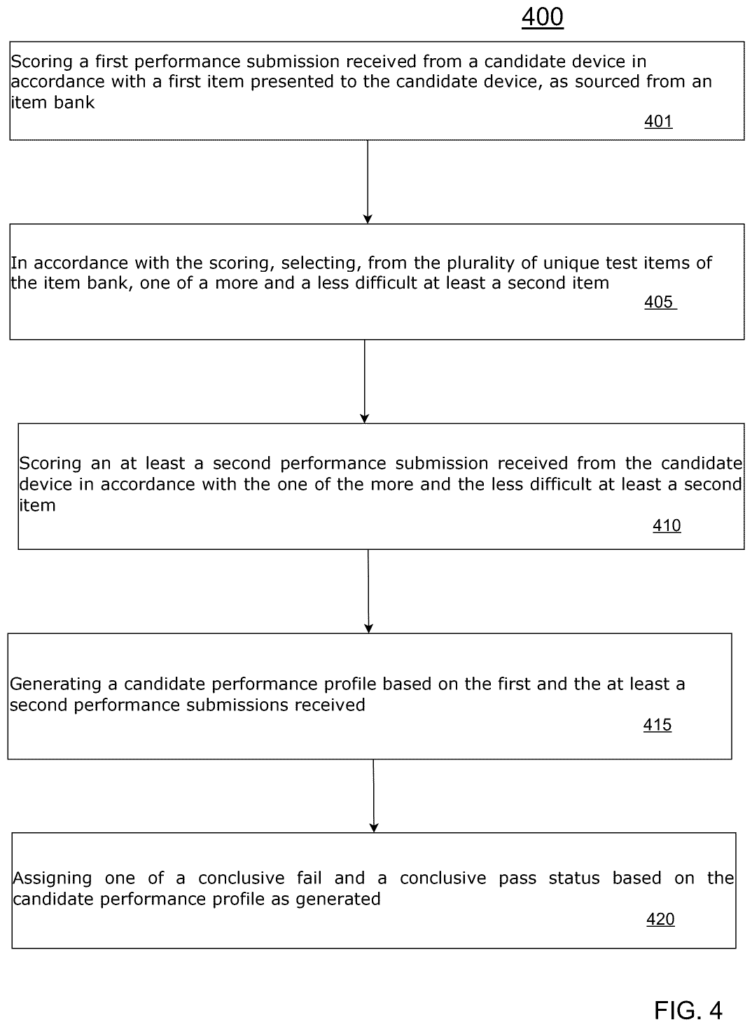

FIG. 4 shows, in an example embodiment, process 400 for deploying adaptive testing via real time continuous scoring. In embodiments, process 400 may be implemented by applying any of the devices, systems, techniques and features as described in FIGS. 1-5. In embodiments, process 400 may be implemented via computer processor executable instructions stored on memory storage media devices. In other embodiments, at least some of the computer processor executable instructions stored on memory storage media devices may be implemented, wholly or at least partially, in electronically hardwired devices, including, without limitation, field programmable gate array (FPGA) semiconductor devices or application specific integrated circuit (ASIC) semiconductor devices.

At step 401, scoring a first performance submission received from candidate computing device 102 in accordance with a first item sourced from item bank 103a that is presented to candidate computing device 102.

At step 405, in accordance with the scoring, selecting, from the plurality of unique test items of the item bank 103a, one of a more and a less difficult at least a second item.

At step 410, scoring an at least a second, or any number of subsequent performance submission(s) received from candidate computing device 102 in accordance with the one of the more and the less difficult at least a second item.

At step 420, generating a candidate performance profile based on the first and the at least a second performance submissions received.

At step 425, assigning one of a conclusive fail and a conclusive pass status The method of claim 1 wherein the test comprises a target subset of the plurality of unique test items for presenting to the candidate computing device, and the conclusive pass status is assigned prior to scoring the target subset upon receiving the at least a second performance submission in accordance with the more difficult at least a second item.

In embodiments, the conclusive fail status is assigned prior to scoring the target subset upon receiving the at least a second performance submission in accordance with the less difficult at least a second item.

In some aspects, the plurality of unique test items of the item bank may be distributed among a set of predefined test topics, each predefined test topic of the set including a subset of the plurality that share a classification in accordance with respective ones of multiple levels of difficulty. The classifications may be predetermined in accordance with the multiple levels of difficulty based at least in part on a cumulative history of performance by an entire population of prior test candidates. In some embodiments, the classification of more difficult items item comprises a performance success probability of 40% or less, and items classified as less difficult comprise a performance success probability of 60% or more, the more difficult and the less difficult classifications of items being respectively distributed below and above a target success probability that is predefined in accordance with a 50% success probability. The classifications may be subject to further sub-divisions or sub-classifications in difficulty level, in some variations.

In some embodiments, the test comprises one or more of linear and linear on the fly test (LOFT) test configurations, and the test is concluded responsive to assigning the one of the conclusive fail and the conclusive pass status. In some variations, the conclusive pass status and the conclusive fail status are respectively assigned responsive to at least one of a predetermined number of the first and at least a second items and a predetermined percentage of the first and at least a second items being answered correctly or incorrectly based on the real time continuous scoring.

In some embodiments, the candidate performance profile comprises performance results selected from prior examination performance results from examination undertakings by a given test candidate associated with the candidate computing device. Yet further, in some variations, the first item may be selected in accordance with a first level of difficulty that is established based at least in part upon the prior examination performance results of the test candidate.

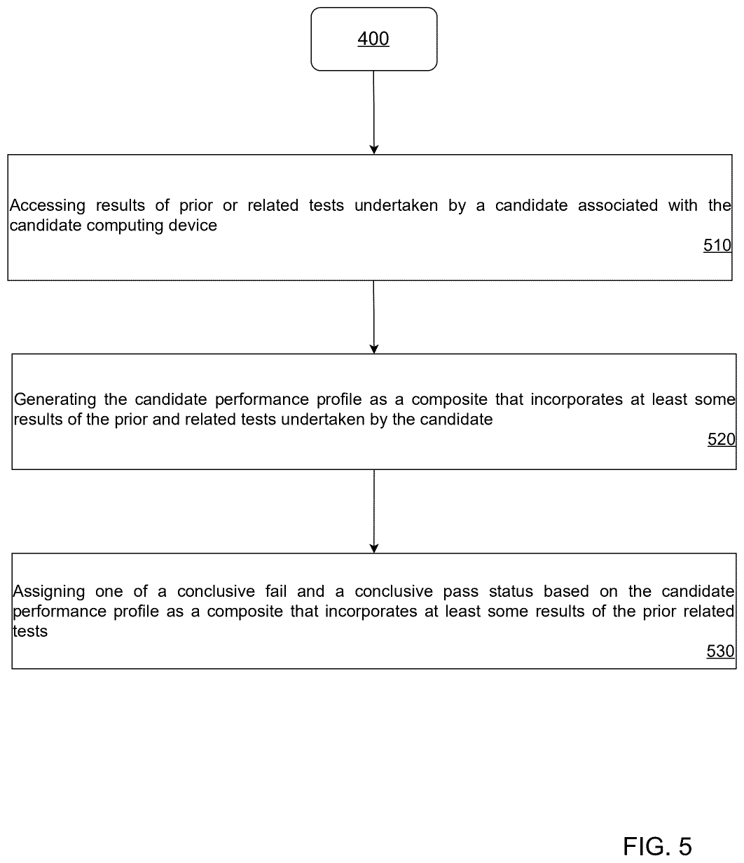

FIG. 5 shows, in an example embodiment, process 500 for deploying adaptive testing via real time continuous scoring. In embodiments, process 500 may be implemented by applying any of the devices, systems, techniques and features as described in FIGS. 1-5. In embodiments, process 500 may be implemented via computer processor executable instructions stored on memory storage media devices. In other embodiments, at least some of the computer processor executable instructions stored on memory storage media devices may be implemented, wholly or at least partially, in electronically hardwired devices, including, without limitation, field programmable gate array (FPGA's) devices or application specific integrated circuit (ASIC) semiconductor devices. In particular, process 500 represents a modification or variation in the embodiment of FIG. 4 that incorporates results of prior, related examination results that a given candidate may have attained in order to provide a composite performance profile that is more comprehensive than just based on the single examination undertaken as described in regard to FIG. 4.

At step 510, accessing results of prior or related tests undertaken by a candidate associated with the candidate computing device.

At step 520, generating the candidate performance profile as a composite that incorporates at least some results of the prior and related tests undertaken by the candidate.

At step 530, assigning one of a conclusive fail and a conclusive pass status based on the candidate performance profile as a composite that incorporates at least some results of the prior related tests

It is contemplated that embodiments described herein be understood to include and encompass varying combinations of elements and concepts recited anywhere in this application. Although embodiments are described in detail herein with reference to the accompanying drawings, it is to be understood that the invention is not limited to only such literal embodiments. For example, it is anticipated that the techniques and systems may be applied or deployed to cases other than any particular test configurations including but not necessarily limited to, linear and linear on the fly (LOFT). Furthermore, it is contemplated that a particular feature described either individually or as part of an embodiment can be combined with other features as described, or parts of other embodiments, even in the absence of a particular described combination. Thus, absence of particular described combinations does not preclude the inventor from claiming rights to such combinations. As such, many modifications and variations will be apparent to practitioners skilled in the art. Accordingly, it is intended that the scope of the invention be defined by the following claims and their equivalents.

What is claimed is:

1. A method of rendering a test having a plurality of test questions (‘items’) sourced from an item bank that includes a plurality of unique test items, the method comprising:
scoring a first performance submission received from a candidate computing device in accordance with a first item sourced from the item bank that is presented to the candidate computing device;
in accordance with the scoring, selecting, from the plurality of unique test items of the item bank, one of a more and a less difficult at least a second item;
scoring an at least a second performance submission received from the candidate computing device in accordance with the one of the more and the less difficult at least a second item;
generating a candidate performance profile based at least on the first and the at least a second performance submissions received; and
assigning one of a conclusive fail and a conclusive pass status based on the candidate performance profile as generated.

2. The method of claim 1 wherein the test comprises a target subset of the plurality of unique test items for presenting to the candidate computing device, and the conclusive pass status is assigned prior to scoring the target subset upon receiving the at least a second performance submission in accordance with the more difficult at least a second item.

3. The method of claim 2 wherein the conclusive fail status is assigned prior to scoring the target subset upon receiving the at least a second performance submission in accordance with the less difficult at least a second item.

4. The method of claim 1 wherein ones of the plurality of unique test items of the item bank are distributed among a set of predefined test topics, each predefined test topic of the set including a subset of the plurality that share a classification in accordance with respective ones of multiple levels of difficulty.

5. The method of claim 4 wherein the classification in accordance with the multiple levels of difficulty is based at least in part upon a cumulative history of performance by a population of prior test candidates.

6. The method of claim 5 wherein the more difficult at least a second item comprises a performance success probability of 40% or less, and the less difficult at least a second item comprises a performance success probability of 60% or more, the more difficult and the less difficult classifications of items being distributed at one of above and below a target success probability that is predefined in accordance with a 50% success probability.

7. The method of claim 1 wherein the test comprises a linear on the fly test (LOFT), and the test is concluded responsive to assigning the one of the conclusive fail and the conclusive pass status.

8. The method of claim 1 wherein the conclusive pass status and the conclusive fail status are respectively assigned responsive to at least one of a predetermined number of the first and at least a second items and a predetermined percentage of the first and at least a second items being answered correctly and incorrectly in accordance with the scoring.

9. The method of claim 1 wherein the candidate performance profile comprises a set of performance results selected from prior examination performance results in accordance with examination undertakings by a test candidate associated with the candidate computing device.

10. The method of claim 9 wherein the first item is selected in accordance with a first level of difficulty, the first level of difficulty being selected based at least in part upon prior examination performance results of the test candidate.

11. A test delivery server computing system communicatively coupled within a distributed network computing system, the test delivery server computing system comprising:
one or more processors; and
a memory storing instructions executable in the one or more processors, the instructions, when executed in the one or more processors, causing the one or more processors to implement operations including:
scoring a first performance submission received from a candidate computing device in accordance with a first question (‘item’) that is presented to the candidate computing device, the first question being sourced from an item bank that includes a plurality of unique test items;
in accordance with the scoring, selecting, from the plurality of unique test items of the item bank, one of a more and a less difficult at least a second item;
scoring an at least a second performance submission received from the candidate computing device in accordance with the one of the more and the less difficult at least a second item;
generating a candidate performance profile based at least on the first and the at least a second performance submissions received; and
assigning one of a conclusive fail and a conclusive pass status based on the candidate performance profile as generated.

12. The test delivery computing system of claim 11 wherein the test comprises a target subset of the plurality of unique test items for presenting to the candidate computing device, and the conclusive pass status is assigned prior to scoring the target subset upon receiving the at least a second performance submission in accordance with the more difficult at least a second item.

13. The test delivery computing system of claim 12 wherein the conclusive fail status is assigned prior to scoring the target subset upon receiving the at least a second performance submission in accordance with the less difficult at least a second item.

14. The test delivery computing system of claim 11 wherein ones of the plurality of unique test items of the item bank are distributed among a set of predefined test topics, each predefined test topic of the set including a subset of the plurality that share a classification in accordance with respective ones of multiple levels of difficulty.

15. The test delivery computing system of claim 14 wherein the classification in accordance with the multiple levels of difficulty is based at least in part upon a cumulative history of performance by a population of prior test candidates.

16. The test delivery computing system of claim 15 wherein the more difficult at least a second item comprises a performance success probability of 40% or less, and the less difficult at least a second item comprises a performance success probability of 60% or more, the more difficult and the less difficult classifications of items being distributed at one of above and below a target success probability that is predefined in accordance with a 50% success probability.

17. The test delivery computing system of claim 11 wherein the test comprises a linear on the fly test (LOFT), and the test is concluded responsive to assigning the one of the conclusive fail and the conclusive pass status.

18. The test delivery computing system of claim 11 wherein the conclusive pass status and the conclusive fail status are respectively assigned responsive to at least one of a predetermined number of the first and at least a second items and a predetermined percentage of the first and at least a second items being answered correctly and incorrectly in accordance with the scoring.

19. The test delivery computing system of claim 11 wherein the candidate performance profile comprises a set of performance results selected from prior examination performance results in accordance with examination undertakings by a test candidate associated with the candidate computing device.

20. A computer-readable non-transitory memory having instructions stored thereon, the instructions when executed in one or more processors causing the one or more processors to implement operations comprising:
scoring a first performance submission received from a candidate computing device in accordance with a first question (‘item’) that is presented to the candidate computing device, the first question being sourced from an item bank that includes a plurality of unique test items;
in accordance with the scoring, selecting, from the plurality of unique test items of the item bank, one of a more and a less difficult at least a second item;
scoring an at least a second performance submission received from the candidate computing device in accordance with the one of the more and the less difficult at least a second item;
generating a candidate performance profile based at least on the first and the at least a second performance submissions received; and
assigning one of a conclusive fail and a conclusive pass status based on the candidate performance profile as generated.
